(19) United States
(12) Patent Application Publication
(10) Pub. No.: US 2023/0340816 A1
(43) Pub. Date: Oct. 26, 2023

(54) Tension Lock for Assembly Without Tools and System for Assembly of a Tension Lock Without Tools

(71) Applicant: Dieter Ramsauer Patentverwertung GmbH & Co. KG, Ennepetal (DE)

(72) Inventor: Dieter Ramsauer, Schwelm (DE)

(21) Appl. No.: 18/246,753

(22) PCT Filed: Sep. 9, 2021
(86) PCT No.: PCT/EP2021/074772

§ 371 Date: Mar. 27, 2023

(30) Foreign Application Priority Data
Sep. 28, 2020 (DE) 10 2020 125 243.9

(51) Int. Cl. E05C 19/14

(52) U.S. Cl. CPC E05C 19/14

(57) ABSTRACT

The invention relates to a tension lock for mounting, without tools, on two components to be interconnected, including: - a first fastening element for connecting the tension lock to the first component; - a second fastening element for connecting the tension lock to the second component; and - a tensioning lever for actuating the tension lock, the tensioning lever being movably connected to at least one of the two fastening elements. According to the invention, in order to allow the tension lock to be mounted, without tools, on the components to be interconnected, the first fastening element and/or the second fastening element has at least one connecting means for establishing a connection, more particularly an interlocking connection, to an opening in the component, which connection can be made without tools. The invention also relates to a system for mounting a tension lock of this type, without tools, on two components to be interconnected.

### CROSS-REFERENCE TO RELATED APPLICATIONS

This application is the United States national phase of International Application No. PCT/EP2021/074772 filed Sep. 9, 2021, and claims priority to German Patent Application No. 10 2020 125 243.9 filed Sep. 28, 2020, the disclosures of which are hereby incorporated by reference in their entireties.

### BACKGROUND OF THE INVENTION

### Field of the Invention

The invention relates to a tension lock for assembly without tools on two components to be connected to one another, comprising: a first fastening element for connecting the tension lock to the first component, a second fastening element for connecting the tension lock to the second component, and a tension lever for actuating the tension lock, wherein the tension lever is movably connected to at least one of the two fastening elements.

### Description of Related Art

The invention also relates to a system for assembly of a tension lock without tools on two components to be connected to one another, comprising: a previously described tension lock, and two components to be connected to one another.

Tension locks in different configurations are known from the prior art Such tension locks are used to detachably connect two components to one another, for example a door to a door frame. To actuate them, tension locks often have a tension lever, which is configured in such manner that it can only be moved from the closed (“clamped”) position to the open (“non-clamped”) position with a certain amount of force, and thus an unintentional opening is ruled out

One challenge with tension locks is fastening the tension locks to the components to be connected to one another by the tension lock. Special tools are often required for fastening, for example to create rivet connections or to create screw connections. In addition, some types of connections, e.g. welded connections, are very difficult to create with thin-walled components such as metal sheets.

### SUMMARY OF THE INVENTION

The object underlying the invention is therefore to design and further develop a previously described tension lock in such manner that it can be reliably assembled on the components to be connected to one another by the tension lock without using tools.

This object is achieved in the case of a tension lock according to the preamble of claim 1 in that the first fastening element and/or the second fastening element has at least one connecting means for creating an, in particular positive-locking, connection, which can be assembled without tools, with a cut-out provided in the component.

The invention relates to a tension lock, which can be assembled without tools on two components to be connected to one another. The tension lock comprises a first fastening element for connecting the tension lock to the first component and a second fastening element for connecting the tension lock to the second component The two fastening elements are therefore used to connect the tension lock to the components to be connected. Since the components often have flat surfaces, it is preferable that the fastening elements in each case also have at least one flat (contact) surface for contact with the components to be connected. The tension lock also comprises a tension lever for actuating the tension lock. This tension lever is movably connected to at least one of the two fastening elements, for example via an articulated rocker. The tension lever can also be connected to both fastening elements, wherein one of these two connections should be designed to be detachable so that the tension lock can be opened fully.

According to the invention, it is provided that the first fastening element and/or the second fastening element has at least one connecting means for creating an, in particular positive-locking, connection, which can be assembled without tools, with a cut-out provided in the component, i.e. a connection which can be assembled without tools should be achieved by a corresponding design of the fastening elements. Specifically, connecting means protruding from the fastening elements can be provided for this purpose, which can be inserted into the components to be connected (or into cut-outs provided there). In this way, a reliable connection, in particular a positive-locking connection (e.g. a snap connection) and/or a force-fitting connection (e.g. a clamp connection) can be achieved. The components to be connected only need to be prepared by punching or cutting correspondingly shaped cut-outs. The connection is preferably a detachable connection, so that the tension lock can be disassembled again if necessary. Preferably, the connecting means are arranged in such manner that they are enclosed or covered by the tension lever in the closed position of the tension lever. This has the advantage that the connecting means in the assembled state are only accessible from the rear or from the inside when the tension lever is closed. In this way, the tension lock can fulfil the function of a lock (e.g. by the tension lever being lockable), since unauthorised disassembly from the outside is not possible.

According to one configuration of the tension lock, at least one connecting means is configured as a locking hook. The configuration as a hook represents a constructively simple and reliable possibility of creating a connection, in particular a positive-locking connection. For this purpose, the locking hook can be guided through a cut-out in one of the components to be connected in order to engage behind the cut-out from its rear.

A further configuration of the tension lock envisages at least one connecting means being designed as an assembly stand with spring element The configuration as an assembly stand with spring element also represents a constructively simple and reliable possibility of creating a connection, in particular a positive-locking and/or force-fitting connection. For this purpose, the assembly stand can be inserted into a cut-out in one of the components to be connected, wherein the spring element arranged on the assembly stand is elastically deformed due to its elasticity when passing through the cut-out and springs back after passing through (i.e. in the assembled position) and engages behind the edge of the cut-out from the rear of the component.

Each fastening element preferably has a locking hook and an assembly stand with spring element, wherein the locking hook and the assembly stand with the spring element are preferably arranged on opposite sides and in the opposite direction, i.e. “back to back” to one another. In this way, the fastening elements are fixed in their position on two opposite sides of the cut-outs, wherein the fixing is carried out on one side via the locking hooks and wherein the fixing is carried out on the other (opposite) side via the assembly stands and their spring elements.

According to a further configuration of the tension lock, an articulated rocker is provided which is rotatably connected to the tension lever with its first end and which is rotatably connected to one of the two fastening elements with its second end. An articulated rocker can initially be used to achieve a double rotatable bearing. If one of the ends of the articulated rocker (e.g. the end mounted on the fastening element) is also arranged in a stationary manner, it can also be achieved that the other end of the articulated rocker (e.g. the end mounted on the tension lever) is guided along a circular path. In this way, it can be achieved that the tension lever must pass a “dead centre” during closing, whereby it can be achieved that the tension lever then remains in its closed position.

For this purpose, it is further proposed that the tension lever and/or one of the two fastening elements have a receptacle for rotatable mounting of one of the ends of the articulated rocker. By providing a receptacle on the tension lever and/or on one of the two fastening elements, the ends of the articulated rocker can be easily rotatably connected to the tension lever and/or to the fastening element The receptacle, for example, is designed in such manner that the ends of the articulated rocker can be pressed into the receptacles and rotatably held there by a snap connection.

A further configuration of the tension lock provides that the tension lever has a projection and that one of the two components has a recess such that the projection can be introduced into the recess to create a detachable connection. A positive-locking, detachable connection can be easily achieved by means of a projection and a recess. In particular, it can be achieved that the projection hooks in the recess (like a hook). This has the advantage that the greater the tensile load caused by the tension lever, the better the connection holds together.

According to a further configuration of the tension lock, it is provided that the tension lever has at least one handle element The handle element can, for example, be a depression or a projection. The handle element is intended to facilitate gripping and lifting of the tension lever and is therefore preferably arranged at the end of the tension lever, which is to be lifted by the user.

According to a further configuration of the tension lock, it can be provided that the tension lock is manufactured from plastic and/or from metal. In particular, it can be provided that the tension lever and/or the fastening elements are manufactured from plastic and/or from metal. Manufacturing from plastic is cost-effective and allows for flexible forming, while a very high rigidity and tensile strength can be achieved by manufacturing from metal. The different parts of the tension lock can also be manufactured from different materials. Preferably, the parts of the tension lock that can be clipped into the components, i.e. the fastening elements and the connecting means arranged thereon, such as, for example, locking hooks and assembly stand with spring element, are manufactured from plastic, since this simplifies the clipping of the fastening elements due to the high elasticity of plastic. Polyamide or POM-H (homopolymer manufactured from formaldehyde, trade name Delrin) can be used as a plastic, for example. If the tension lock has connecting parts (e.g. an articulated rocker for connecting the tension lever to one of the fastening elements), these connecting parts can be manufactured from plastic or, if particular wear resistance is required, from metal. The object described at the outset is also achieved by a system for the assembly of a tension lock without tools on two components to be connected to one another. The system comprises a tension lock in one of the previously described configurations and two components to be connected to one another. The system is characterised in that the two components each have a cut-out, are optimally adapted to the tension lock and in particular are prepared for the connecting means of the tension lock (e.g. a locking hook or an assembly stand with a spring element) to engage into the cut-outs.

Lastly, according to one configuration of the system, the two components are manufactured from metal sheet and the cut-outs are roughly rectangular. The connection of a tension lock to thin-walled components of metal sheet is particularly challenging, since some joining processes (e.g. welded connections) are difficult to achieve with thin-walled materials. By providing rectangular cut-outs, a positive-locking connection can be easily created, for example if the connecting means of the tension lock (e.g. a locking hook or an assembly stand with a spring element) engage into the cut-outs.

### BRIEF DESCRIPTION OF THE DRAWINGS

The invention will be explained in more detail below on the basis of a drawing which simply represents preferred exemplary embodiments. The drawing shows:

FIG. 1: a tension lock according to the invention in closed position in assembled state in perspective view,

FIG. 2: the tension lock from FIG. 1 in sectioned view along the section plane II-II marked in FIG. 1,

FIG. 3: the tension lock from FIG. 1 in sectioned view along the section plane III-III marked in FIG. 1 in closed position,

FIG. 4: the tension lock from FIG. 3 in open position, and

FIG. 5: the tension lock from FIG. 3 in disassembled position.

### DESCRIPTION OF THE INVENTION

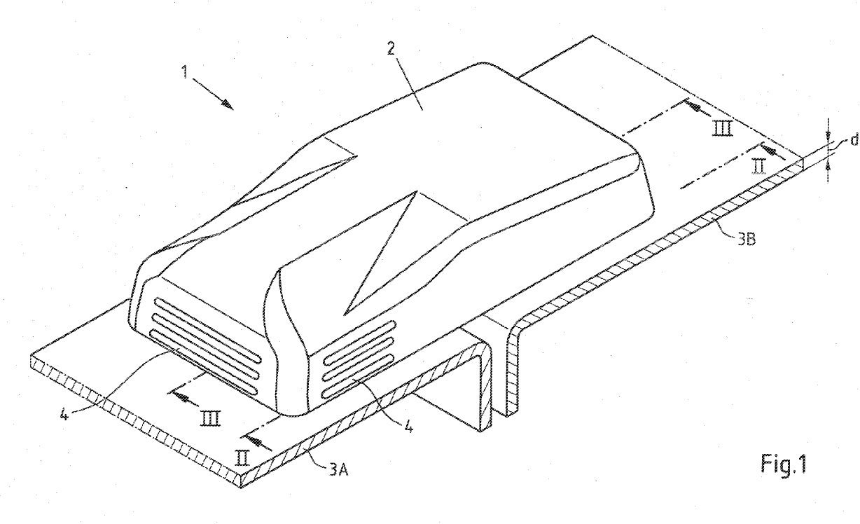

FIG. 1 shows a tension lock 1 according to the invention in closed position in the assembled state in perspective view. Since the tension lock 1 in FIG. 1 is shown in the closed position, only its tension lever 2 is visible. The parts of the tension lock 1 hidden by the tension lever 2 are explained in more detail in connection with the following figures. The tension lock 1 is used to detachably connect a first component 3A to a second component 3B. One of the two components 3A can, for example, be a door, a flap or a cover, while the second component 3B can, for example, be a frame of a door or a cabinet. In the case of the example shown in FIG. 1, the two components 3A, 3B are manufactured from a thin-walled metal sheet, whose thickness d can, for example, be in the range between 0.8 mm and 2.5 mm. If the two components 3A, 3B are not manufactured from metal sheet, but from plastic, the thickness d can also be up to 4 mm. The tension lever 2 has at one end a plurality of handle elements 4, which can, for example, be depressions or projections which facilitate the gripping and lifting of the tension lever 2.

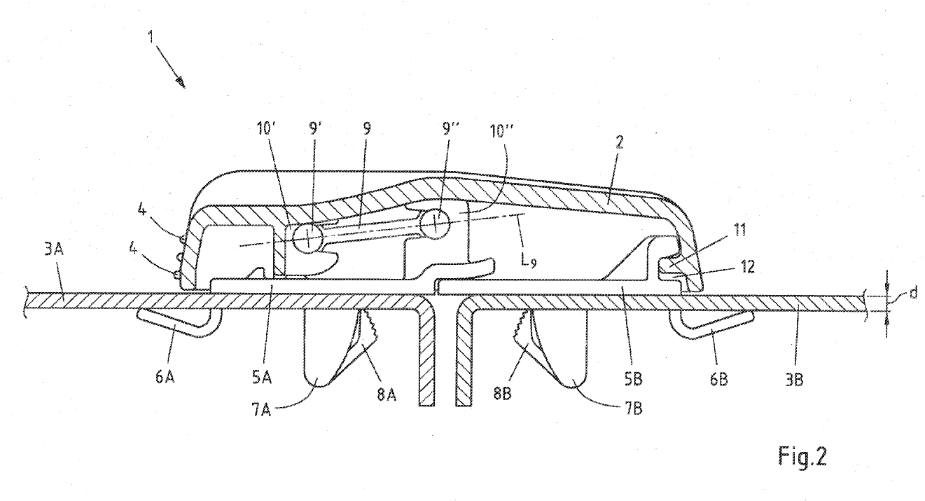

FIG. 2 shows the tension lock 1 from FIG. 1 in sectioned view along the section plane II-II marked in FIG. 1. The previously mentioned regions of the tension lock 1 are provided in FIG. 2 with corresponding reference numerals. In FIG. 2, it is discernible that, in addition to the tension lever 2, the tension lock 1 also has a first fastening element 5A and a second fastening element 5B. The first fastening element 5A is used to create a connection with the first component 3A, for which purpose the first fastening element 5A has a locking hook 6A and an assembly stand 7A with an elastic spring element 8A. The second fastening element 5B, on the other hand, is used to create a connection with the second component 3B, for which purpose the second fastening element SB also has a locking hook 6B and an assembly stand 7B with an elastic spring element 8B. The connection of the two fastening elements 5A, 5B to the two components 3A, 3B is explained in more detail in connection with the following figures.

The tension lock 1 shown in FIG. 2 also has an articulated rocker 9 via which the tension lever 2 is movably connected to the first fastening element SA. To this end, both the tension lever 2 and the first fastening element 5A each have a receptacle 10 in which the articulated rocker 9 is rotatably mounted, wherein the first end 9′ of the articulated rocker 9 is mounted in the first receptacle 10′ and wherein the second end 9″ of the articulated rocker 9 is mounted in the second receptacle 10″. The articulated rocker 9 has a longitudinal axis L₉ which runs through the first end 9′ and through the second end 9″ of the articulated rocker 9. The tension lever 2 can also be connected to the second fastening element 5B, for which purpose the tension lever 2 has a projection 11 at its end opposite the handle elements 4 and for which purpose the second fastening element 5B has a recess 12, into which the projection 11 can engage in order to create a positive-locking, detachable, connection. Alternatively, the projection 11 could be provided on the second fastening element 5B and the recess 12 could be provided on the tension lever 2.

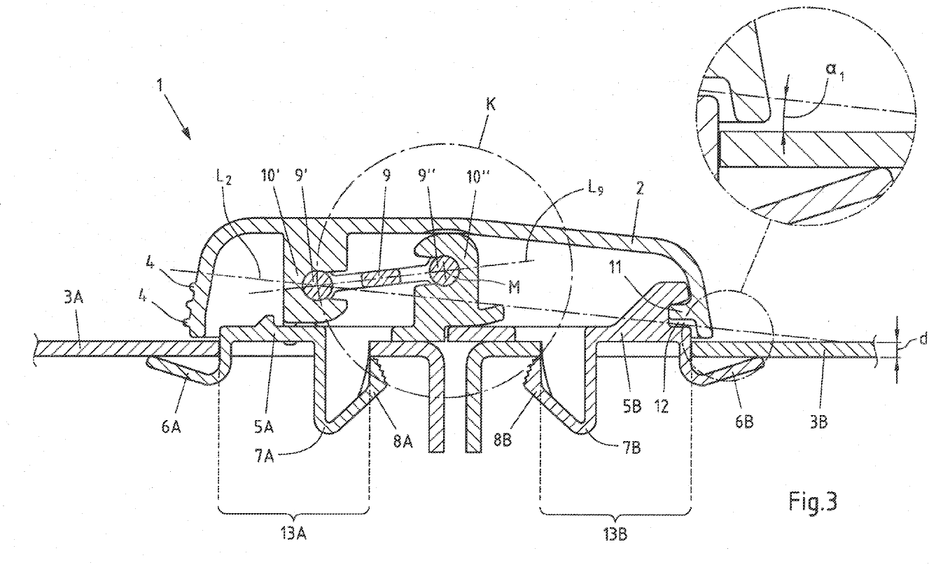

FIG. 3 shows the tension lock 1 from FIG. 1 in sectioned view along the section plane III -III marked in FIG. 1 in closed position. The regions of the tension lock 1 already previously mentioned are also provided in FIG. 3 with corresponding reference numerals. Due to the changed position of the section plane, it is discernible that the first component 3A has a first cut-out 13A into which engage the locking hook 6A and the assembly stand 7A with its elastic spring element 8A of the first fastening element 5A and create a positive-locking, detachable, connection between the first component 3A and the first fastening element 5A. It is also discernible that the second component 3B has a second cut-out 13B into which engage the locking hook 6B and the assembly stand 7B with its elastic spring element 8B of the second fastening element 5B and create a positive-locking, detachable connection between the second component 3B and the second fastening element 5B.

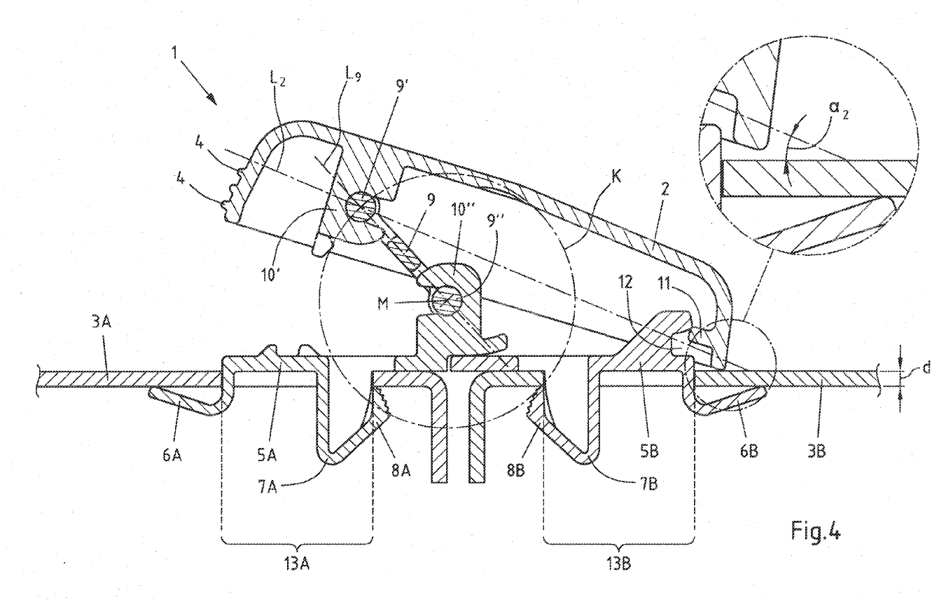

The closed position of the tension lock 1 shown in FIG. 3 is characterised in that the tension lever 2 has a longitudinal axis L₂, which forms a tension lever angle α₁ with the surfaces of the first component 3A and the second component 3B, said tension lever angle being in the range between 0° and 15°, in particular in the range between 0° and 10°. The tension lever 2 can be moved from the closed position (shown in FIG. 3) into the open position (shown in FIG. 4) by lifting the tension lever 2 in the region of its handle elements 4. This leads to a rotational movement of the first end 9′ of the articulated rocker 9 along a circular path K, whose centre M is formed by the second end 9″ of the articulated rocker 9. In closed position shown in FIG. 3, the articulated rocker 9 is arranged in such manner that its first end 9′ is arranged deeper (i.e. closer to the surfaces of the first component 3A and the second component 3B) than its second end 9″ such that the longitudinal axis L₉ of the articulated rocker 9 rises, running from the first end 9′ to the second end 9″.

FIG. 4 shows the tension lock 1 from FIG. 3 in open position. The regions of the tension lock 1 already previously mentioned are also provided in FIG. 4 with corresponding reference numerals. The open position differs from the closed position by a changed position of the tension lever 2: In the open position of the tension lever 2, the longitudinal axis L₂ forms a tension lever angle α₂ with the surfaces of the first component 3A and the second component 3B which is greater than 10°, in particular greater than 15° and thus steeper than in the closed position. In the open position shown in FIG. 4, the position of the articulated rocker 9 is also changed; it is arranged in such manner that its first end 9′ is arranged higher (i.e. further away from the surfaces of the first component 3A and the second component 3B) than its second end 9″ such that the longitudinal axis L₉ of the articulated rocker 9 slopes, running from the first end 9′ to the second end 9″, in FIG. 4 it is also discernible that lifting the tension lever 2 results in the projection 11 of the tension lever 2 being pushed out of the recess 12 of the second fastening element 5B, whereby the positive-locking connection between the second fastening element 5B and the tension lever 2 can be detached such that the tension lever 2 can be lifted off the second fastening element 5B and is then only connected (via the articulated rocker 9) to the first fastening element 5A. In this way, the first fastening element 5A and the second fastening element 5B can be connected to one another (closed position of the tension lever 2) and separated from one another (open position of the tension lever 2). The separation of projection 11 and recess 12 when lifting the tension lever 2 is a consequence of the movement of the first end 9′ of the articulated rocker 9 along the circular path K, which means that when the tension lever 2 is lifted, the projection 11 is first pulled deeper into the recess 12 until a “dead centre” (longitudinal axis L₉ of the articulated rocker 9 parallel to the surfaces of the first component 3A and the second component 3B) is reached, and after it has been exceeded, the projection 11 is pushed back out of the recess 12. Such a “dead centre” is a typical feature of tension locks, since this can be achieved in that the tension lever is moved into a desired position (in particular in the closed position) and does not open unintentionally.

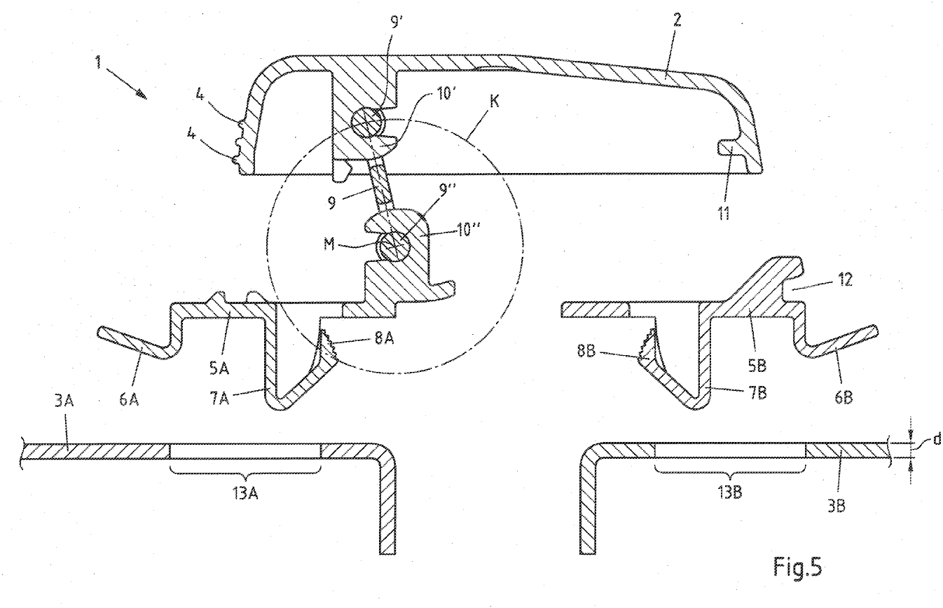

FIG. 5 lastly shows the tension lock 1 from FIG. 3 in the disassembled position. The regions of the tension lock 1 already previously mentioned are also provided in FIG. 5 with corresponding reference numerals. In the disassembled position, the individual components of the tension lock 1 can be seen more clearly. It is particularly clear how the two fastening elements 5A, 5B can be connected to the two components 3A, 3B: There are cut-outs 13A, 13B in the two components 3A, 3B, which are preferably approximately rectangular (the width can, for example, be in the range between 10 mm and 15 mm and the length can, for example, be in the range between 15 mm and 25 mm). The two fastening elements 5A, 5B have connecting means which can, for example, be designed as locking hooks 6A, 6B and assembly stand 7A, 7B with spring element 8A, 8B. The connection is created by first inserting the locking hooks 6A, 6B into the cut-outs 13A, 13B in such manner that they engage behind the edges of the cut-outs 13A, 13B from the rear of the two components 3A, 3B. The assembly stands 7A, 7B are then inserted into the cut-outs 13A, 13B, wherein the spring elements 8A, 8B arranged on the assembly stands 7A, 7B spring in the direction of the locking hooks 6A, 6B due to their elasticity when passing through the cut-outs 13A, 13B and spring back after passing through (i.e. in the assembled position) and engage behind the edges of the cut-outs 13A, 13B from the rear of the two components 3A, 3B. In this way, the fastening elements 5A, 5B are each fixed in their position on respectively two opposite sides of the cut-outs 13A, 13B, wherein the fixing on one side takes place via the locking hooks 6A, 6B and wherein the fixing on the other (opposite) side takes place via the assembly stands 7A, 7B and their spring elements 8A, 8B. Alternatively, the locking hooks 6A, 6B could each be replaced with an assembly stand 7A, 7B and a spring element 8A, 8B arranged thereon such that each fastening element 5A, 5B can have two assembly stands 7A, 7B and two tension hooks 8A, 8B.

List of reference numerals:

| | |
|---|---|
| 1: | Tension lock |
| 2: | Tension lever |
| 3A, 3B: | Component |
| 4: | Handle element |
| 5A, 5B: | Fastening element |
| 6A, 6B: | Locking hook |
| 7A, 7B: | Assembly stand |
| 8A, 8B: | Spring element |
| 9: | Articulated rocker |
| 9′, 9″: | End (of the articulated rocker 9) |
| 10, 10′, 10″: | Receptacle |
| 11: | Projection |
| 12: | Recess |
| 13A, 13B: | Cut-out |
| α₁, α₂: | Tension lever angle |
| d: | Thickness (of the components 3A, 3B) |
| K: | Circular path |
| L₂: | Longitudinal axis (of the tension lever 2) |
| L₉: | Longitudinal axis (of the articulated rocker 9) |
| M: | Centre (of the circular path K) |

1. A tension lock for assembly without tools on two components to be connected to one another, comprising:
a first fastening element for connecting the tension lock to the first component,
a second fastening element for connecting the tension lock to the second component, and
a tension lever for actuating the tension lock, wherein the tension lever is movably connected to at least one of the two fastening elements,
wherein the first fastening element and/or the second fastening element has at least one connecting means for creating an, in particular positive-locking, connection, which can be assembled without tools, with a cut-out provided in the component,
wherein at least one connecting means is designed as a locking book, and
wherein at least on connecting means is designed as a mounting block with a spring element, wherein
each fastening element has a locking hook and a mounting block with a spring element and in that the locking hook and the block with spring element are arranged on opposite sides and in opposite directions to one another for fixing the fastening elements in their position on two opposite sides of the cutouts respectively .

2. (canceled)

3. (canceled)

4. The tension lock according to claim 1 wherein
an articulated rocker which is rotatably connected to the tension lever with its first end and which is rotatably connected to one of the two fastening elements with its second end.

5. The tension lock according to claim 4, wherein
the tension lever and/or one of the two fastening elements have a receptacle for rotatable mounting of one of the ends of the articulated rocker.

6. The tension lock according to (Currently Amended) The tension lock according to claim 5, wherein
the tension lever has a projection and in that one of the two components has a recess such that the projection can be inserted into the recess to create a detachable connection.

7. The tension lock according to claim 5, wherein
the tension lever has at least one handle element.

8. The tension lock according to claim 6, wherein
the tension lock is manufactured from plastic and/or metal.

9. The system for assembly of a tension lock without tools on two components to be connected to one another, comprising:
a tension lock according to claim 8, and
two components to be connected to one another, wherein
the two components each have a cut-out.

10. The system according to claim 9, wherein
the two components are manufactured from metal sheet and the cut-outs are approximately rectangular.
